(19) United States
(12) Patent Application Publication
(10) Pub. No.: US 2011/0320863 A1
(43) Pub. Date: Dec. 29, 2011

(54) DYNAMIC RE-ALLOCATION OF CACHE BUFFER SLOTS

(75) Inventors: Ekaterina M. Amroladze, Fishkill, NY (US); Deanna Postles Dunn Berger, Poughkeepsie, NY (US); Michael Fee, Cold Spring, NY (US); Arthur J. O'Neill, JR., Poughkeepsie, NY (US); Diana Lynn Orf, Somerville, MA (US); Robert J. Sonnelitter, III, Wappinger Falls, NY (US)

(73) Assignee: INTERNATIONAL BUSINESS MACHINES CORPORATION, Armonk, NY (US)

(21) Appl. No.: 12/822,407

(22) Filed: Jun. 24, 2010

(51) Int. Cl. G06F 11/20; G06F 12/08; G06F 11/00

(52) U.S. Cl. 714/6.1; 711/141; 711/E12.017; 714/E11.084

(57) ABSTRACT

Dynamic re-allocation of cache buffer slots includes moving data out of a reserved buffer slot upon detecting an error in the reserved buffer slot, creating a new buffer slot, and storing the data moved out of the reserved buffer slot in the new buffer slot.

### BACKGROUND

Exemplary embodiments relate generally to cache storage systems, and more particularly to dynamic re-allocation of reserved cache buffer slots.

Modern high performance computer systems require many data paths to interconnect the large number of devices within the system. These pathways, or interconnects, utilize a large number of data buffers to temporarily hold data as it moves through the computer system. To reduce the complexity of the data paths and the number of unique dedicated data buffers, some systems provide assigned, fixed locations in the computer system's cache arrays (buffer slots) for use as temporary data buffers. These cache buffer slots are initialized into this special state at system start up and remain fixed in location for as long as the system is active.

With advancements that allow larger and denser memory caches (e.g., SRAM and eDRAM) on a single chip, the chances of the occurrence of errors become greater with each new generation. While single bit errors can be corrected by the error correction code (ECC) that normally protects the data, hard errors that occur in the cache arrays result in data corruption each time the cache buffer slot is used. Simply removing the buffer slot from use would result in a loss of system processing capability, so the ability to re-assign the cache data buffer location would be a beneficial option.

### BRIEF SUMMARY

An embodiment is a method of dynamically re-allocating cache buffer slots. The method includes moving data out of a reserved buffer slot upon detecting an error in the reserved buffer slot, creating a new buffer slot, and storing the data moved out of the reserved buffer slot in the new buffer slot.

An additional embodiment is a system for dynamically re-allocating cache buffer slots. The system includes a central processor, and modules configured for execution on the central processor. The modules include a cache management module configured to move data out of a reserved buffer slot upon detecting an error in the reserved buffer slot. The modules also include a castout module configured to create a new reserved buffer slot, the new reserved buffer slot configured to receive the data moved out of the reserved buffer slot.

A further embodiment is a computer program product. The computer program product includes a tangible storage medium readable by a processing circuit and storing instructions for execution by the processing circuit for performing a method. The method includes moving data out of a reserved buffer slot upon detecting an error in the reserved buffer slot, creating a new buffer slot, and storing the data moved out of the reserved buffer slot in the new buffer slot.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE SEVERAL VIEWS OF THE DRAWINGS

Referring now to the drawings wherein like elements are numbered alike in the several FIGURES:

FIG. 1 depicts a system including a cache topology upon which cache buffer slot management may be implemented in an exemplary embodiment;

FIG. 2 depicts an example of a node-to-node fabric topology that may be used in implementing cache buffer slot management in accordance with an exemplary embodiment;

FIG. 3 depicts a detailed portion of the system of FIG. 1 upon which cache buffer slot management may be implemented in an exemplary embodiment;

FIGS. 4A-4B are flow diagrams describing a process for implementing cache buffer slot management in an exemplary embodiment; and

FIG. 5 is a computer program product in an exemplary embodiment.

### DETAILED DESCRIPTION

Exemplary embodiments provide a mechanism for moving a location of a cache buffer slot along with any data it contains to another cache buffer slot in the same address index when an error is detected. This mechanism enables the slot movement to be transparent to the buffer slot users, while also preventing correctable errors from degrading into uncorrectable errors which can negatively impact system operation.

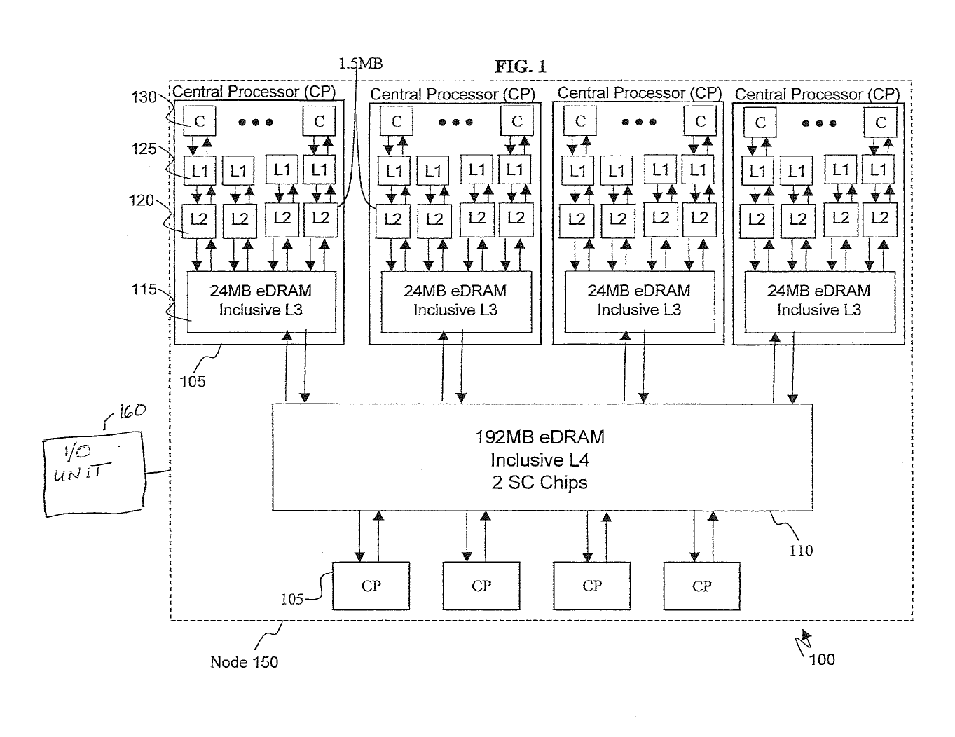

Turning now to FIG. 1, a system 100 (including cache topology) for implementing the cache buffer slot management will now be described in an exemplary embodiment. The system of FIG. 1 illustrates a plurality of central processors (CP) 105 (also referred to as central processing units) operatively connected via busses to one or more L4 caches 110. Although not shown in FIG. 1, each of the central processors (CP) 105 includes one or more cores 130 which perform the reading and executing of instructions. On each central processor (CP) 105, the multiple cores 130 are operatively connected via busses to L1, L2, and L3 caches 125, 120, and 115. The L1 caches 125 are physically closest to the cores 130, followed by the L2 caches 120, and then the L3 caches 115. It is understood that the designation of caches could be reversed.

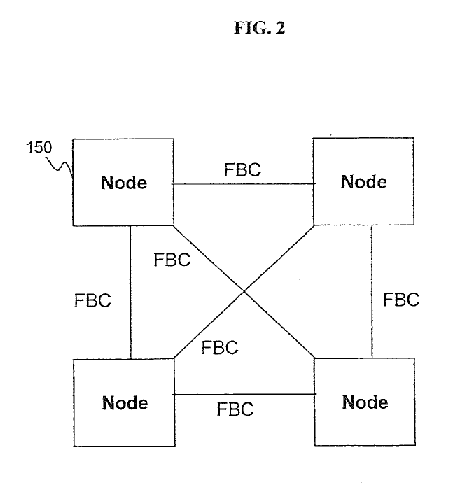

Also shown in the system 100 is an L4 cache 110. The L4 cache 110 is operatively coupled to the CPs 105 and provides a shared memory space for each of the CPs 105. Although the L3 and L4 caches 115 and 110 are illustrated in FIG. 1 as embedded dynamic random access memory (DRAM), which is referred to as eDRAIVI, it will be understood by a skilled artisan that any other types of suitable memory may be utilized in realizing the exemplary embodiments. The central processors 105 operatively connected to one or more L4 caches 110 collectively form a node 150. In a computing system, multiple such nodes 150 may be operatively connected to one another for communicating, such as broadcasts, snooping, cache intervention, and responses. FIG. 2 illustrates an example of multiple nodes 150 operatively connected to one another via, e.g., one or more point-to-point buses, referred to herein as a system fabric.

The system 100 is communicatively coupled to an input/output (I/O) unit 160. The I/O unit 160 may include, e.g., an I/O hub, adapters, and interface elements for performing various operations in connection with the central processors 105.

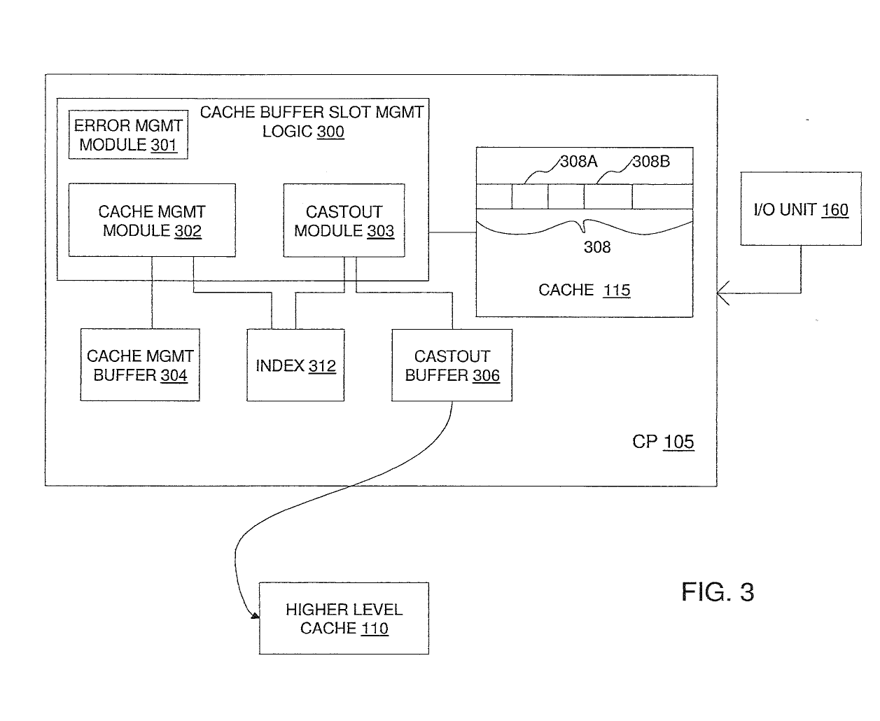

The system 100 further includes various components for implementing the cache buffer slot management described herein. These various components are described further in FIG. 3.

Each individual central processor 105 is fabricated on its own separate chip, which includes the L1, L2, and L3 caches 125, 120, and 115, while the L4 cache 110 is fabricated on its own separate chip. As understood by a skilled artisan, fabrication of chips including integrated circuits, wires, metal layers, semiconductor (and/or other material) components, etc., may be formed via lithography and other techniques. The fabrication process may include various deposition techniques including physical vapor deposition (PVD), chemical vapor deposition (CVD), electrochemical deposition (ECD), molecular beam epitaxy (MBE), and atomic layer deposition (ALD) among others.

The exemplary cache buffer slot management processes may be implemented for cache storage systems that dynamically allocate reserved cache buffer slots on demand. For example, cache management control processes are disclosed in commonly assigned U.S. Patent Application Attorney Docket No. POU920100121US1, entitled ON DEMAND ALLOCATION OF CACHE BUFFER SLOTS, filed concurrently with the instant application, the contents of which are incorporated by reference herein in its entirety. The processes described in the reference disclose buffer slots are initially configured for performing data storage pursuant to default methods and, upon a request by an operation to utilize a cache buffer slot, the cache management controls pause the requested operation, dynamically create the reserved buffer slot, and then permit the operation to proceed and utilize the slot. This allows the cache to use those slots for normal data storage until such an operation arrives requests the usage of that space as a buffer. The exemplary cache buffer slot management processes provide a means to move the location of a cache buffer slot along with any data it contains to another cache buffer slot when an error is detected.

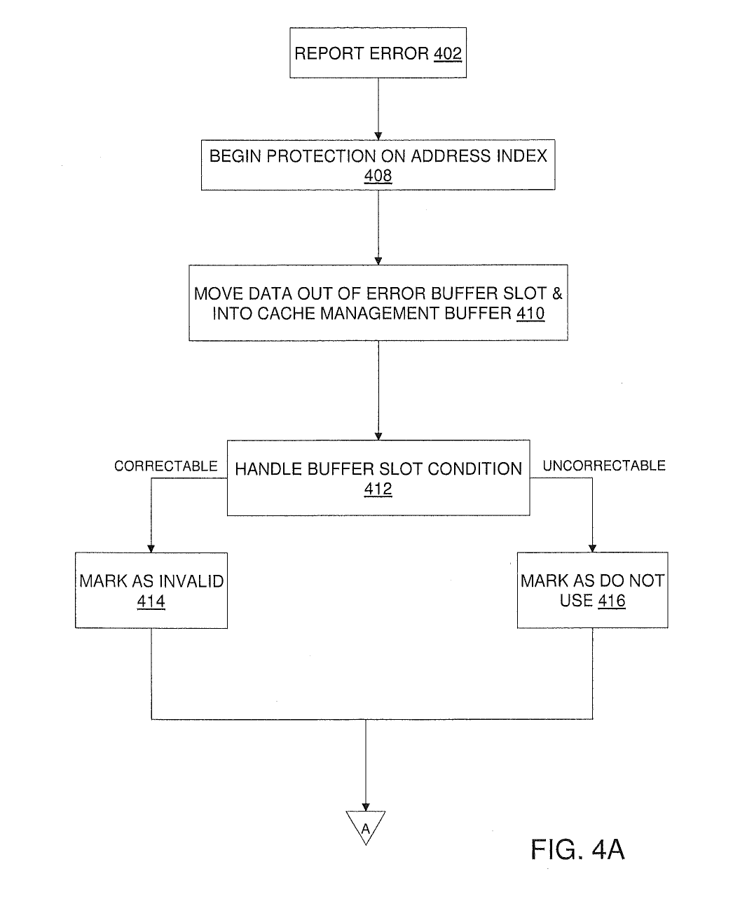

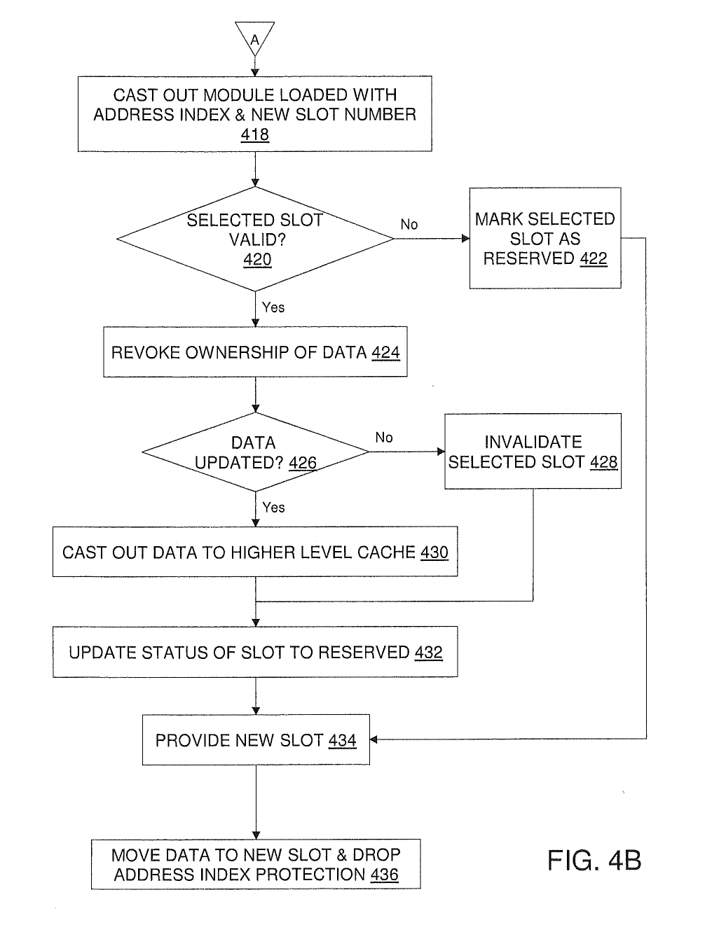

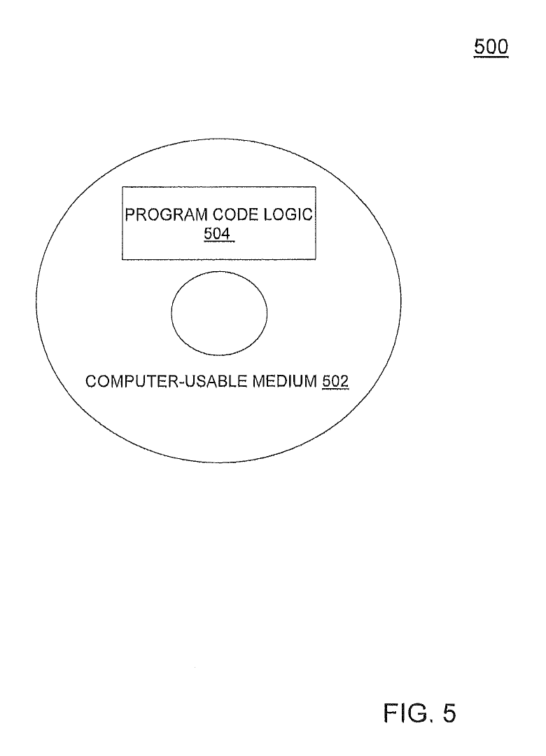

Turning now to FIG. 3, a detailed portion of the system 100 of FIG. 1 will now be described in an exemplary embodiment. As shown in FIG. 3 each central processor 105 may include cache buffer slot management logic 300 in communication with a cache management buffer 304, a castout buffer 306, an index 312, and caches 115 and 110. In an alternative embodiment, the logic 300, buffers 306 and index 312 may be implemented elsewhere in the system 100, e.g., within another level of cache, such as cache 110. In an exemplary embodiment, the cache buffer slot management logic 300 includes an error management module 301, a cache management module 302, and a castout module 303. The cache 115 includes buffer slots 308, the locations of which may be moved along with any data to other cache buffer slots 308 in the same address index 312 when an error is detected. The cache buffer slot management logic 302 is implemented by the central processor 105 for performing the exemplary cache buffer slot management functions. The functionality of the cache management buffer 304, castout buffer 306, and index 312 is described further in FIGS. 4A-4B.

Turning now to FIGS. 4A-4B an exemplary process for implementing cache buffer slot management will now be described in an exemplary embodiment. For illustrative purposes, the process described in FIGS. 4A-4B use operations from an I/O unit (e.g., anything that is external to the cache logic, such as pins), such as I/O unit 160, and an I/O buffer slot (e.g., one or more of slots 308) is used for reservation.

When access to the buffer slot results in an error being detected, the error is reported to the error management module 301 at block 402. The error report may include the type of error detected (i.e., correctable or uncorrectable) as described further herein. The buffer slot for which an error is detected is referred to as the ‘original buffer slot,’ ‘erroneous buffer slot,’ and ‘original reserved buffer slot’ 308A in order to distinguish it from other slots 308 in the cache.

The cache management module 302 places a protection on the whole address index 312 at block 408 by reporting address compares so that any operation targeting that address index 312 will have to wait until this operation is done. The cache management module 302 moves data out of the erroneous buffer slot 308A into its own buffer 304 at block 410 and determines a buffer slot condition (e.g., one of correctable or uncorrectable) at block 412. If the slot 308A has a correctable error, which means its data can be fixed while guaranteeing its accuracy, then the slot 308A is marked as ‘invalid’ so it can be used again for regular cache storage. In this instance, the data is corrected before storing it into the new buffer slot.

If the data is not correctable, which means that there is no algorithm that can figure out what the data should be, then the slot 308A is marked as ‘do not use’ to prevent the use of the slot 308A in the future. In this instance, the data is marked as corrupt when moving the data into the new buffer slot.

Accordingly, if the data is found to be correctable, the cache management module 302 marks the erroneous buffer slot 308A as ‘invalid’ at block 414 so it can be used for general data storage, or if uncorrectable, it marks the erroneous buffer slot 308A as ‘do not use’ at block 416.

The process proceeds to FIG. 4B, whereby the castout module 303 is loaded with the address index 312 and slot 308B's number at block 418. The index 312 is the same index for each of the slots 308A and 308B (i.e., the slots 308A and 308B are two slots within the same index 312). The castout module 303 then checks if the selected buffer slot 308B is currently valid at block 420. A buffer slot is valid if it is being used (i.e., there is data in the slot). A buffer slot is invalid if it is not being used (i.e., there is no data in the slot). If the selected buffer slot 308B is invalid, then the castout module 303 marks the selected buffer slot 308B as I/O reserved at block 422 followed by providing the selected buffer slot 308B at block 434.

If there is valid data in the selected buffer slot 308B, the castout module 303 requests lower-level caches (e.g., cache 115) to revoke the ownership of the data in the selected buffer slot 308B at block 424. At block 426, it is determined whether the data in the selected buffer slot 308B been changed (i.e., modified since ownership of the data has been established). If the data has not been changed, the castout module 303 invalidates the selected buffer slot 308B at block 428 and the process proceeds to block 432. If the data has been changed (updated), the castout module 303 casts out the data from the selected buffer slot 308B to a higher level cache (e.g., cache 110) once lower level caches (e.g., cache 120, 125) have rescinded ownership of the castout data at block 430. In one embodiment, the castout data may be retained temporarily in the castout buffer 306 before moving the castout data to the higher level cache (e.g., cache 110). Once the castout data has been moved or invalidated, the castout module 303 updates the status of the selected buffer slot 308B in the index 312 to being reserved at block 432. Once the castout module 303 is finished, it indicates to the cache management module 302 that the reserved buffer slot 308B is now created and provides the new buffer slot 308B for storing the data from the cache management buffer 304 at block 434.

The cache management module 302 moves this data into the newly created buffer slot 308B and it drops its address index protection at block 436.

Technical effects include moving a location of a cache buffer slot along with any data it contains to another cache buffer slot in the same address index when an error is detected. This mechanism enables the slot movement to be transparent to the buffer slot users, while also preventing correctable errors from degrading into uncorrectable errors which can negatively impact system operation.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product 500 embodied in one or more computer readable medium(s) 502 having computer readable program code embodied thereon 504.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A computer program product for dynamic re-allocation of cache buffer slots, comprising a tangible storage medium readable by a processing circuit and storing instructions for execution by the processing circuit for performing a method comprising:
moving data out of a reserved buffer slot upon detecting an error in the reserved buffer slot;
creating a new buffer slot; and
storing the data moved out of the reserved buffer slot in the new buffer slot.

2. The computer program product of claim 1, wherein moving the data out of the reserved buffer slot includes:
placing a protection on an index that stores an address of the reserved buffer slot; and
moving the data into a temporary buffer.

3. The computer program product of claim 1, wherein moving the data out of the reserved buffer slot comprises:
determining a condition of the reserved buffer slot; and
upon determining the condition is correctable, marking the reserved buffer slot as ‘invalid,’ the condition of ‘invalid’ permitting the reserved buffer slot to be used for data storage, wherein the method further comprises correcting the data before storing the corrected data in the new buffer slot.

4. The computer program product of claim 1, wherein moving the data out of the reserved buffer slot comprises:
determining a condition of the reserved buffer slot; and
upon determining the condition is uncorrectable, marking the reserved buffer slot as ‘do not use,’ the condition of ‘do not use’ preventing the reserved buffer slot from being used for data storage, and marking the data as corrupt when moving the data into the new buffer slot.

5. The computer program product of claim 1, wherein creating the new buffer slot includes:
determining whether the new buffer slot contains data;
upon determining the new buffer slot does not contain data, marking the new buffer slot as input/output reserved.

6. The computer program product of claim 1, wherein creating the new buffer slot includes:
determining whether the new buffer slot contains data;
upon determining the new buffer slot contains data:
revoking ownership of the data in the new buffer slot;
determining whether the data in the new buffer slot has been updated;
if the data in the new buffer slot has been updated, casting out the data in the new buffer slot to a level of cache further away from a central processor than a level of cache in which the new buffer slot is contained;
if the data in the new buffer slot has not been updated, invalidating the new buffer slot;
updating a status of the new buffer slot as input/output reserved.

7. The computer program product of claim 1, wherein storing the data moved out of the reserved buffer slot in the new buffer slot comprises:
removing a protection on an index that stores an address of the reserved buffer slot.

8. A system for dynamic re-allocation of cache buffer slots, the system comprising:
a central processor; and
modules configured for execution on the central processor, the modules comprising:
a cache management module configured to move data out of a reserved buffer slot upon detecting an error in the reserved buffer slot; and
a castout module configured to create a new reserved buffer slot, the new reserved buffer slot configured to receive the data moved out of the reserved buffer slot.

9. The system of claim 8, wherein moving the data out of the reserved buffer slot includes:
placing a protection on an index that stores an address of the reserved buffer slot; and
moving the data into a temporary buffer.

10. The system of claim 8, wherein moving the data out of the reserved buffer slot comprises:
determining a condition of the reserved buffer slot; and
upon determining the condition is correctable, marking the reserved buffer slot as ‘invalid,’ the condition of ‘invalid’ permitting the reserved buffer slot to be used for data storage, wherein the method further comprises correcting the data before storing the corrected data in the new buffer slot.

11. The system of claim 8, wherein moving the data out of the reserved buffer slot comprises:
determining a condition of the reserved buffer slot; and
upon determining the condition is uncorrectable, marking the reserved buffer slot as ‘do not use,’ the condition of ‘do not use’ preventing the reserved buffer slot from being used for data storage, and marking the data as corrupt when moving the data into the new buffer slot.

12. The system of claim 8, wherein creating the new buffer slot includes:
determining whether the new buffer slot contains data;
upon determining the new buffer slot does not contain data, marking the new buffer slot as input/output reserved.

13. The system of claim 8, wherein creating the new buffer slot includes:
determining whether the new buffer slot contains data;
upon determining the new buffer slot contains data:
revoking ownership of the data in the new buffer slot;
determining whether the data in the new buffer slot has been updated;
if the data in the new buffer slot has been updated, casting out the data in the new buffer slot to a level of cache further away from a central processor than a level of cache in which the new buffer slot is contained;
if the data in the new buffer slot has not been updated, invalidating the new buffer slot;
updating a status of the new buffer slot as input/output reserved.

14. The system of claim 8, wherein storing the data moved out of the reserved buffer slot in the new buffer slot comprises:
removing a protection on an index that stores an address of the reserved buffer slot.

15. A computer-implemented method for dynamic re-allocation of cache buffer slots, the method comprising:
moving data out of a reserved buffer slot upon detecting an error in the reserved buffer slot;
creating a new buffer slot; and
storing the data moved out of the reserved buffer slot in the new buffer slot

16. The computer-implemented method of claim 15, wherein moving the data out of the reserved buffer slot includes:
placing a protection on an index that stores an address of the reserved buffer slot; and
moving the data into a temporary buffer.

17. The computer-implemented method of claim 15, wherein moving the data out of the reserved buffer slot comprises:
determining a condition of the reserved buffer slot; and
upon determining the condition is correctable, marking the reserved buffer slot as ‘invalid,’ the condition of ‘invalid’ permitting the reserved buffer slot to be used for data storage, wherein the method further comprises correcting the data before storing the corrected data in the new buffer slot.

18. The computer-implemented method of claim 15, wherein moving the data out of the reserved buffer slot comprises:
determining a condition of the reserved buffer slot; and
upon determining the condition is uncorrectable, marking the reserved buffer slot as ‘do not use,’ the condition of ‘do not use’ preventing the reserved buffer slot from being used for data storage, and marking the data as corrupt when moving the data into the new buffer slot.

19. The computer-implemented method of claim 15, wherein creating the new buffer slot includes:
determining whether the new buffer slot contains data;
upon determining the new buffer slot does not contain data, marking the new buffer slot as input/output reserved.

20. The computer-implemented method of claim 15, wherein creating the new buffer slot includes:
determining whether the new buffer slot contains data;
upon determining the new buffer slot contains data:
revoking ownership of the data in the new buffer slot;
determining whether the data in the new buffer slot has been updated;
if the data in the new buffer slot has been updated, casting out the data in the new buffer slot to a level of cache further away from a central processor than a level of cache in which the new buffer slot is contained;
if the data in the new buffer slot has not been updated, invalidating the new buffer slot;
updating a status of the new buffer slot as input/output reserved.
